(19) United States
(12) Patent Application Publication
(10) Pub. No.: US 2011/0011691 A1
(43) Pub. Date: Jan. 20, 2011

(54) LOCKUP DEVICE

(75) Inventor: Naoki Tomiyama, Osaka (JP)

Correspondence Address: GLOBAL IP COUNSELORS, LLP, 1233 20TH STREET, NW, SUITE 700, WASHINGTON, DC, 20036-2680, US

(73) Assignee: EXEDY CORPORATION, Neyagawa-shi, Osaka (JP)

(21) Appl. No.: 12/922,295

(22) PCT Filed: Feb. 26, 2009
(86) PCT No.: PCT/JP2009/053483

§ 371 Date: Sep. 13, 2010

(30) Foreign Application Priority Data
Apr. 2, 2008 (JP) 2008-096601

(51) Int. Cl. F16H 45/02

(52) U.S. Cl. 192/3.29

(57) ABSTRACT

A lockup device has a piston, an input member, and a damper mechanism. The damper mechanism has a plurality of first elastic members, a plurality of second elastic members, an intermediate member, and an output member. The intermediate member supports the first and second elastic members such that the first and second elastic members operate in series and can undergo elastic deformation in a rotational direction.

### CROSS-REFERENCE TO RELATED APPLICATIONS

This U.S. National stage application claims priority under 35 U.S.C. §119(a) to Japanese Patent Application No. 2008-096601, filed in Japan on Apr. 2, 2008, the entire contents of which are hereby incorporated herein by reference.

### BACKGROUND

1. Technical Field

The present invention relates to a lockup device for a fluid-type power transmitting device.

2. Background Information

A known example of a fluid-type power transmitting device is a torque converter. A torque converter has a front cover to which power is delivered, an impeller, a turbine connected to an input shaft of a transmission, and a stator. Power inputted to the front cover is transmitted to the turbine through a hydraulic oil. A torque converter is also provided with a lockup device to couple mechanically the front cover and the turbine together.

The lockup device is arranged between the turbine and the front cover and serves as a mechanism to transmit power directly from the front cover to the turbine by mechanically coupling the front cover and the turbine together.

A lockup device typically includes a piston, a retaining plate, and a damper mechanism contrived to couple elastically the front cover and the turbine together in a rotational direction (e.g., see Japanese Laid-open Patent Publication No. 2001-82577).

The piston has a circular disk shaped piston body and a cylindrical section that extends in an axial direction from an outer circumferential portion of the piston body. The retaining plate is fixed to the piston. The damper mechanism has a first coil spring, a second coil spring, an intermediate plate, and an output plate fixed to the turbine. The first coil spring is arranged on a radially inward side of the cylindrical section and is supported by the piston and the retaining plate such that it can undergo elastic deformation. The first coil spring is arranged on a radially inward side of the cylindrical section and is supported by the piston and the retaining plate such that it can undergo elastic deformation.

In a conventional lockup device, the first coil spring is arranged in a radially inward position relative to the cylindrical section of the piston in consideration of a centrifugal force that acts on the first coil spring. Consequently, a dimension of the first coil spring is limited by an amount corresponding to a thickness of the cylindrical portion and a degree of design freedom for the lockup device tends to decline.

### SUMMARY

An object of the present invention is to increase the degree of design freedom for a lockup device.

A lockup device according to a first aspect of the invention is configured to be used in a fluid-type power transmitting device having an input rotary body provided to receive an input of power and an output rotary body configured to receive a transmission of power that has been inputted to the input rotary body and transmitted through a fluid. The lockup device serves to couple mechanically the input rotary body and the output rotary body together. The lockup device has a piston, an input member, and a damper mechanism. The piston is provided such that it can be frictionally coupled to the input rotary body. The input member is fixed to the piston. The damper mechanism serves to couple elastically the piston and the output rotary body together in a rotational direction and has a plurality of first elastic members, a plurality of second elastic members, an intermediate member, and an output member. The first elastic members are provided such that power transmitted to the piston is transmitted to the first elastic members through the input member. The second elastic members are arranged farther inward in a radial direction than the first elastic members. The intermediate member supports the first and second elastic members such that the first and second elastic members operate in a series and can undergo elastic deformation in a rotational direction. The output member is fixed to the output rotary body and provided such that it can touch against an end portion of the second elastic members in a rotational direction.

In this lockup device, since the first and second elastic members are held by the intermediate member, substantially no load acts on the piston even if a centrifugal force acts on the first elastic members. As a result, it is not necessary to provide a large cylindrical section on the piston and a dimension of the first elastic member is less likely to be restricted by the cylindrical section. Thus, the degree of design freedom for the lockup device can be increased.

A lockup device according to a second aspect of the invention is a lockup device according to the first aspect, wherein the piston has a piston body and a cylindrical section extending in an axial direction from an outer circumferential portion of the piston body. A radially outermost surface of the intermediate member is arranged to be farther outward in a radial direction than a radially inward-facing surface of the cylindrical section.

A lockup device according to a third aspect of the invention is a lockup device according to the second aspect, wherein the first elastic members are arranged to be closer to the output rotary body in an axial direction than the cylindrical section.

A lockup device according to a fourth aspect of the invention is a lockup device according to any one of the first to third aspects, wherein the input member is inserted rotationally between the end portions of adjacent first elastic members in an axial direction from the input rotary body side such that the damper mechanism can be removed in the direction of the output rotary body with respect to the piston.

A lockup device according to a fifth aspect of the invention is a lockup device according to any one of the first to fourth aspects, wherein the input member has a fastening section that is fastened to the piston and a plurality of claw-like portions that extends toward the output rotary body from an outer circumferential portion of the fastening section. A lockup device according to a sixth aspect of the invention is a lockup device according to any one of the first to fifth aspects, wherein the intermediate member is supported in a radial direction by the output member.

### BRIEF DESCRIPTION OF THE DRAWINGS

FIG. 1 is a cross sectional schematic view of a torque converter.

FIG. 2 is a cross sectional schematic view of a lockup device of the torque converter.

FIG. 3 is a plan schematic view of the lockup device.

FIG. 4 is a torsional characteristic diagram for a damper mechanism of the lockup device.

### EXEMPLARY EMBODIMENTS

Embodiments of the present invention will now be explained based on the drawings.

### Overall Configuration of Torque Converter

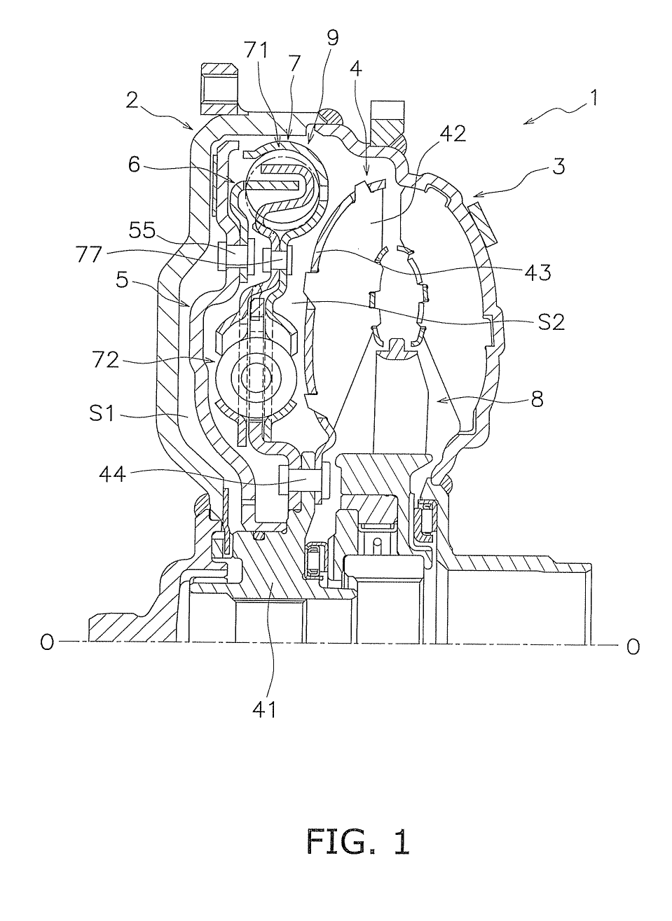

The overall configuration of a torque converter 1 will now be explained using FIG. 1. FIG. 1 is a vertical cross sectional schematic view of the torque converter 1. In FIG. 1, an engine (not shown) is arranged on a left-hand side of the torque converter 1 and a transmission (not shown) is arranged on a right-hand side of the torque converter 1. The line O-O shown in FIG. 1 is a rotational axis of the torque converter 1.

The torque converter 1 is a device for transmitting power generated by an engine to a transmission via a fluid and has a front cover 2, an impeller 3, a turbine 4, a stator 8, and a lockup device 9.

The front cover 2 receives power from the engine. The impeller 3 is fixed to the front cover 2. The front cover 2 and the impeller 3 form a fluid chamber filled with a lubricating oil.

The turbine 4 is provided in the fluid chamber. The turbine 4 is coupled to an input shaft of the transmission and has a turbine shell 43, a plurality of turbine blades 42 fixed to the turbine shell 43, and a turbine hub 41 fixed to the turbine shell 43 with a plurality of rivets 44. The turbine hub 41 is coupled to the input shaft.

A stator 8 is provided between the turbine 4 and the impeller 3. The lockup device 9 is arranged between the turbine 4 and the front cover 2.

### Configuration of Lockup Device

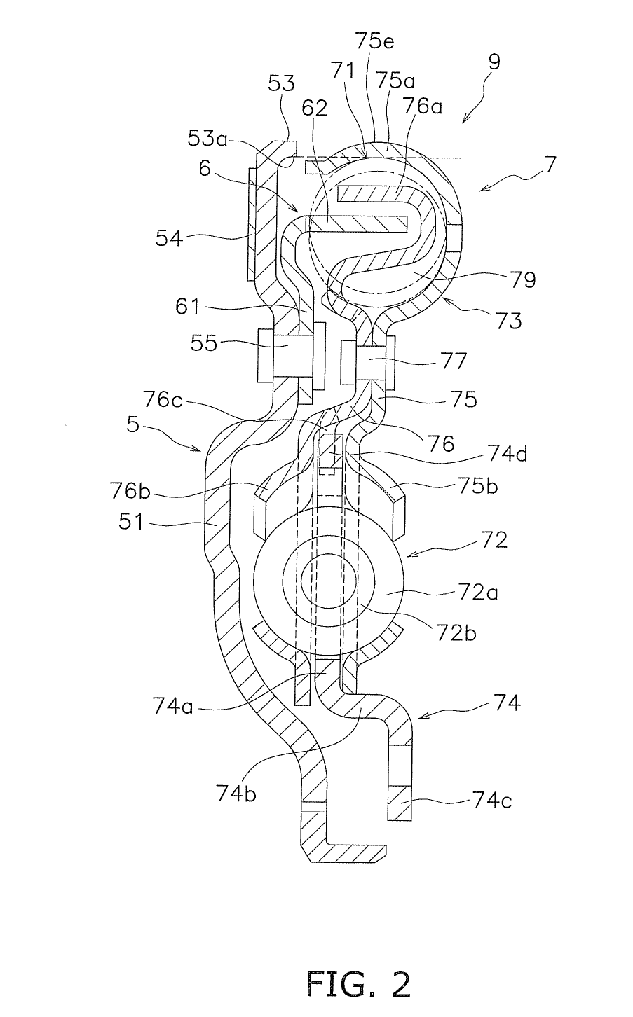

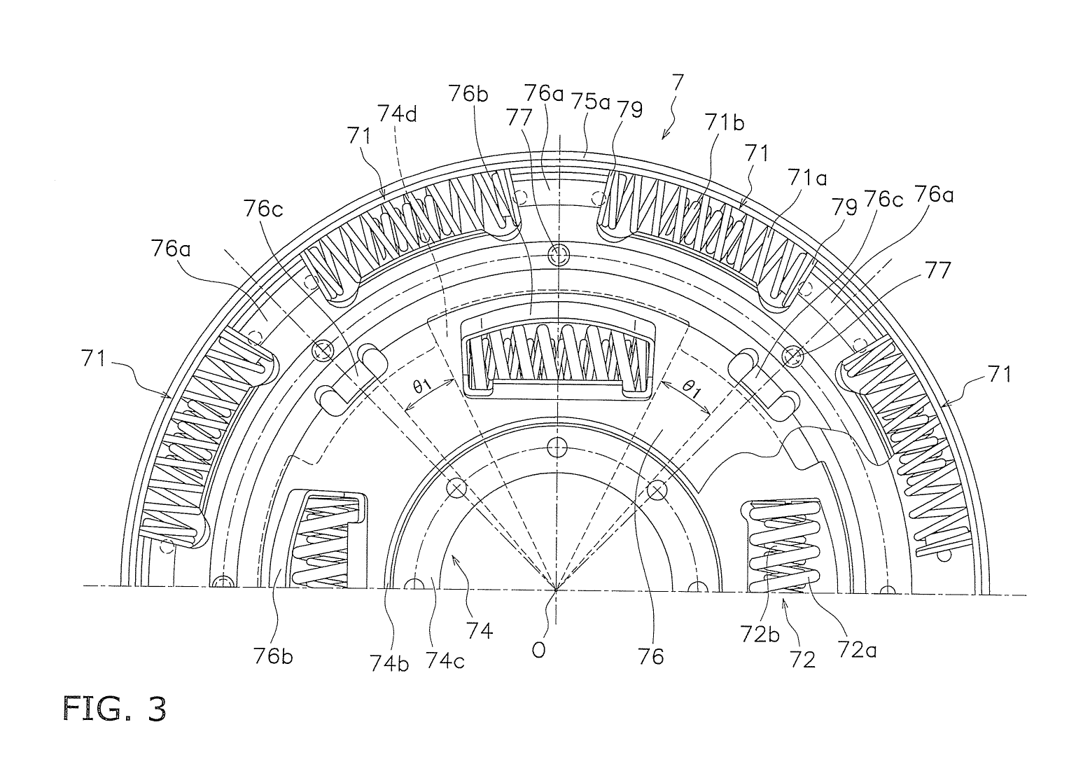

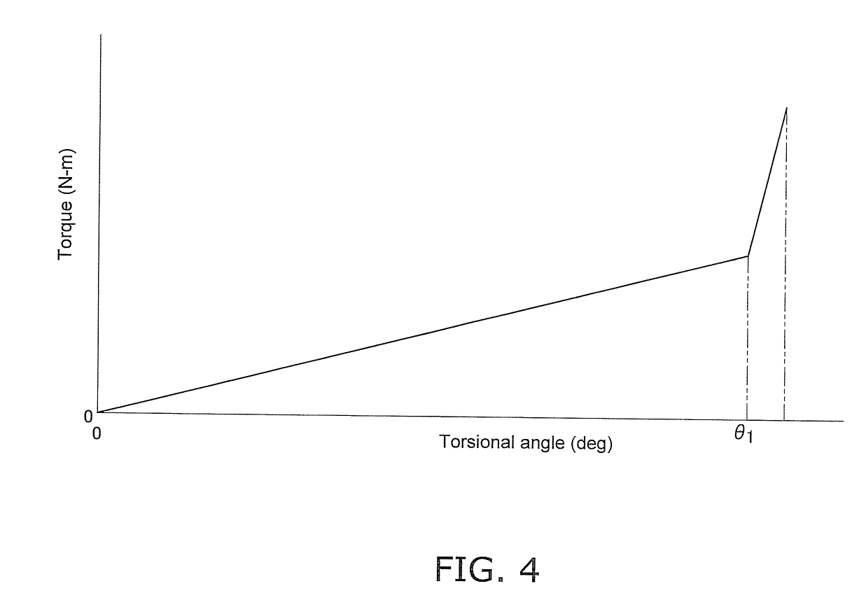

The lockup device 9 will now be explained using FIGS. 2 to 4. FIG. 2 is a cross sectional schematic view of the lockup device 9. FIG. 3 is a plan schematic view of the lockup device 9. FIG. 4 is a torsional characteristic diagram of a damper mechanism 7.

The lockup device 9 is a device for mechanically coupling the front cover 2 and the turbine 4 together and has a piston 5, a drive plate 6 (example of input member), and the damper mechanism 7.

The piston 5 is provided such that it can be coupled frictionally to the front cover 2 and is supported by the turbine hub 41 such that the piston 5 can be moved in an axial direction. The piston 5 has a piston body 51, a friction member 54 fixed to an outer circumferential portion of the piston body 51, and a cylindrical section 53 that extends in an axial direction from an outer circumferential portion of the piston body 51.

The drive plate 6 is a member for transmitting power to the damper mechanism 7 and is fixed to the piston body 51 of the piston 5. More specifically, the drive plate 6 has an annular fastening section 61 and a plurality of claw-like portions 62, and the fastening section 61 is fastened to the piston body 51 with rivets 55. The claw-like portions 62 extend in an axial direction toward the transmission from an outer circumferential portion of the fastening section 61 and can touch against outer spring assemblies 71 (explained later) of the damper mechanism 7 in a rotational direction.

The damper mechanism 7 has a two-stage torsional characteristic, as shown in FIG. 4, and has outer spring assemblies 71 (example of first elastic members), inner spring assemblies 72 (example of second elastic members), an intermediate member 73, and an output plate 74 (example of output member).

The outer spring assembly 71 has first outer coil springs 71a, second outer coil springs 71b, and spring seats 79 against which end portions of the first outer coil springs 71a are installed. The spring seats 79 can touch against the claw-like portions 62 of the drive plate 6 in a rotational direction. The second outer coil springs 71b are arranged inside the first coil springs 71a and have shorter lengths in a rotational direction than the first outer coil springs 71a. The first outer coil springs 71a are compressed in a first stage and a second stage. The second outer coil springs 71b are compressed only in the second stage.

The inner spring assemblies 72 are arranged farther inward in a radial direction than the outer spring assembly 71 and have first inner coil springs 72a and second inner coil springs 72b. The second inner coil springs 72b are arranged inside the first coil springs 72a and have substantially the same length as the first inner coil springs 72a. The first inner coil springs 72a and the second inner coil springs 72b are both compressed at the first stage and the second stage.

The outer spring assemblies 71 and the inner spring assemblies 72 are held by the intermediate member 73 such that they can undergo elastic deformation in a rotational direction. More specifically, the intermediate member 73 has a first support plate 75, a second support plate 76, and rivets 77 that connect the first support plate 75 and the second support plate 76 together.

The first support plate 75 has an outer support section 75a serving to hold the outer spring assembly 71 and a first support section 75b serving to hold the inner spring assembly 72. An outer circumferential portion of the outer support section 75a is arranged in substantially the same position in a radial direction as the cylindrical section 53 of the piston 5. More specifically, a radially outermost surface 75e of the outer support section 75a is arranged to be farther outward in a radial direction than a radially inward-facing surface 53a of the cylindrical section 53. The outer support section 75a and the outer spring assemblies 71 are arranged closer to the transmission in an axial direction than the cylindrical portion 53.

The second support plate 76 has a plurality of second support sections 76a configured to support end portions of the springs of the outer spring assembly 71, a plurality of third support sections 76b configured to hold the inner spring assembly 72 in conjunction with the first support section 75b, and a plurality of first protruding sections 76c configured to extend in a radially inward direction.

The output plate 74 is arranged axially between the first support plate 75 and the second support plate 76 such that it can rotate relative to the same. The output plate 74 is fixed to the turbine hub 41 with the rivets 44 and has a main body section 74a, a cylindrical section 74b, a fastening section 74c, and second protruding sections 74d.

The main body section 74a can touch against the inner spring assembly 72 in a rotational direction. The cylindrical section 74b is a cylindrical portion extending in an axial direction toward the transmission from an inner circumferential portion of the main body section 74a. The cylindrical section 74b can touch against an inner circumferential portion 75b of the first support plate 75 in a radial direction. The intermediate member 73 is positioned in a radial direction by the cylindrical section 74b. Thus, the outer spring assembly 71, the inner spring assembly 72, and the intermediate member 73 are supported by the output plate 74. The fastening section 74c is a portion that extends in a radially inward direction from an end portion of the cylindrical section 74b and is fastened to the turbine hub 41 with the rivets 44.

The second protruding sections 74d is arranged in substantially the same position in an axial direction as the first protruding sections 76c of the second support plate 76. In a neutral state in which power is not being transmitted to the damper mechanism 7, a rotational-direction gap is secured between the first protruding sections 76c and the second protruding sections 74d. A first angle θ1 is a torsional angle corresponding to the gap. The first protruding sections 76c touch against the second protruding sections 74d and restrict relative rotation between the intermediate member 73 and the output plate 74. The first protruding sections 76c and the second protruding sections 74d constitute a stopper mechanism of the intermediate member 73 and the output plate 74.

The damper mechanism 7 is provided such that it can be removed from the piston 5 and the drive plate 6 in an axial direction. More specifically, the claw-like portions 62 extend in an axial direction toward the transmission from the engine side of the damper mechanism 7 and fit rotationally between the springs of the outer spring assembly 71. The outer spring assemblies 71 and the inner spring assemblies 72 are provided as a single assembly held together by the intermediate member 73. As a result, the damper mechanism 7 can be assembled to the piston 5 and the drive plate 6 from the transmission side.

### Operation of Torque Converter

Operation of the torque converter 1 will now be explained.

When the front cover 2 is coupled to the turbine 4 by the lockup device 9, a hydraulic oil is discharged from a first space S1. As a result, a pressure in a second space S2 (a space on a turbine 4 side of the piston 5) becomes higher than a pressure in the first space S1 and the piston 5 moves toward the front cover 2 due to the pressure difference. As a result, the friction member 54 of the piston 5 is pressed against the front cover 2 such that power inputted to the front cover 2 is transmitted to the outer spring assemblies 71 through the drive plate 6.

When power is transmitted to the outer spring assembly 71, the piston 5 and the turbine 4 undergo relative rotation and the outer spring assemblies 71 and the inner spring assemblies 72 are compressed between the second support sections 76a of the second support plate 76 and the output plate 74. The outer spring assemblies 71 and the inner spring assemblies 72 are compressed in series.

As shown in FIGS. 3 and 4, the first outer coil springs 71a, the first inner coil springs 72a, and the second inner coil springs 72b are compressed until a first angle θ1 is reached. When the relative rotational angle between the intermediate member 73 and the outer plate 74 reaches the first angle θ1, the first protruding sections 76c and the second protruding sections 74d contact one another in a rotational direction and relative rotation between the second support plate 76 and the output plate 74 stops. From this state, when the piston 5 rotates further relative to the intermediate member 73, the first outer coil springs 71a and the second outer coil springs 71b are compressed in parallel. In this way, the damper mechanism 7 exhibits the second stage of the torsional characteristic.

Meanwhile, when the coupled state of the lockup device 9 is released, the hydraulic oil is supplied to the first space S1 by a hydraulic pump (not shown). As a result, the pressure of the first space S1 becomes equal to or higher than the pressure of the second space S2 and the piston 5 moves toward the turbine 4. Thus, the piston 5 can rotate relative to the front cover 2 and power cannot be transmitted through the lockup device 9. Instead, power is transmitted through the hydraulic oil.

### Distinctive Features

The distinctive features of the lockup device 9 will now be explained.

(1) With this lockup device 9, since the outer spring assemblies 71 and the inner spring assemblies 72 are held by the intermediate member 73, substantially no load acts on the piston 5 when a centrifugal force acts on the outer spring assembly 71. As a result, it is not necessary to provide a cylindrical section having a large thickness on the piston 5 and a dimension of the outer spring assemblies 71 are less likely to be restricted by the cylindrical section. Thus, the degree of design freedom of the lockup device 9 can be increased.

Also, the weight of the piston 5 can be reduced because a cylindrical section having a large thickness is not provided on the piston 5.

(2) Since a radially outermost surface of the intermediate member 73 is arranged to be farther outward in a radial direction than a radially inward-facing surface 53a of the cylindrical section 53, the outer spring assemblies 71 can be arranged farther outward in a radial direction than in a conventional device and an outer diameter of the springs of the outer spring assembly 71 can be increased. Thus, the degree of design freedom of the lockup device 9 can be increased even further.

(3) Since the outer spring assemblies 71 are arranged on the transmission side of the cylindrical section 53 of the piston 5 in an axial direction, the outer spring assemblies 71 can be arranged farther outward in a radial direction than in a conventional device and an outer diameter of the springs of the outer spring assembly 71 can be increased.

(4) Since the outer spring assemblies 71 and the inner spring assemblies 72 are held by the intermediate member 73, the damper mechanism 7 can be handled as a single assembly. As a result, the lockup device 9 can be installed more easily.

(5) The claw-like sections 62 of the dry plate 6 extend toward the transmission in an axial direction so as to be disposed between end portions of adjacent springs of the outer spring assembly 71. As a result, the damper mechanism 7 can be assembled to the piston 5 and the dry plate 6 in an axial direction from the transmission side and the lockup device 9 can be installed more easily.

### OTHER EMBODIMENTS

The specific constituent features of the present invention are not limited to those of the previously described embodiment and various modifications and revisions can be made without departing from the scope of the invention as defined in the claims.

(1) Although in the previously explained embodiments piston 5 has a cylindrical section 53, it is also feasible for the piston 5 not to have a cylindrical section 53. Without a cylindrical section, the weight of the piston 5 can be reduced even more.

The strength of an outer circumferential portion of the piston 5 can be ensured by providing a cylindrical section 53 on the piston 5.

(2) Although in the previously explained embodiment the fluid-type power transmitting device is a torque converter 1, the device equipped with the lockup device 9 is not limited to a torque converter. For example, it is acceptable if the fluid-type power transmitting device is a fluid coupling.

### INDUSTRIAL APPLICABILITY

A lockup device according to the present invention increases the degree of freedom with respect to design. Therefore, the present invention is useful in the field of lockup devices.

1. A lockup device configured to be used in a fluid-type power transmitting device having an input rotary body provided to receive an input of power and an output rotary body configured to receive a transmission of power having been inputted to the input rotary body and transmitted to the output rotary body through a fluid, the lockup device mechanically coupling the input rotary body and the output rotary body together and comprising:
a piston provided to be frictionally coupled to the input rotary body;
an input member fixed to the piston; and
a damper mechanism elastically coupling the piston and the output rotary body in a rotational direction, the damper mechanism including
a plurality of first elastic members provided to receive power transmitted from the piston via the input member,
a plurality of second elastic members arranged farther inward in a radial direction than the first elastic members,
an intermediate member supporting the first and second elastic members to allow the first and second elastic members to operate in series and to undergo elastic deformation in a rotational direction, and
an output member fixed to the output rotary body and provided to touch against an end portion of the second elastic members in a rotational direction.

2. The lockup device recited in claim 1, wherein
the piston has a piston body and a cylindrical section that extends in an axial direction from an outer circumferential portion of the piston body, and
a radially outermost surface of the intermediate member is arranged to be farther outward in a radial direction than a radially inward-facing surface of the cylindrical section.

3. The lockup device recited in claim 2, wherein
the first elastic members are arranged to be closer to the output rotary body in an axial direction than to the cylindrical section.

4. The lockup device recited in claim 3, wherein
the input member is inserted between rotational end portions of adjacent first elastic members in an axial direction from a piston side of the damper mechanism such that the damper mechanism is removable in an axial direction away from the piston.

5. The lockup device recited in claim 4, wherein
the input member has a fastening section that is fastened to the piston and a plurality of claw-like portions that extend from an outer circumferential portion of the fastening section in the axial direction away from the piston.

6. The lockup device recited in claim 5, wherein
the intermediate member is supported in a radial direction by the output member.

7. The lockup device recited in claim 3, wherein
the input member has a fastening section that is fastened to the piston and a plurality of claw-like portions that extend from an outer circumferential portion of the fastening section in the axial direction away from the piston.

8. The lockup device recited in claim 7, wherein
the intermediate member is supported in a radial direction by the output member.

9. The lockup device recited in claim 3, wherein
the intermediate member is supported in a radial direction by the output member.

10. The lockup device recited in claim 2, wherein
the input member is inserted between rotational end portions of adjacent first elastic members in an axial direction from a piston side of the damper mechanism such that the damper mechanism is removable in an axial direction away from the piston.

11. The lockup device recited in claim 10, wherein
the input member has a fastening section that is fastened to the piston and a plurality of claw-like portions that extend from an outer circumferential portion of the fastening section in the axial direction away from the piston.

12. The lockup device recited in claim 11, wherein
the intermediate member is supported in a radial direction by the output member.

13. The lockup device recited in claim 2, wherein
the input member has a fastening section that is fastened to the piston and a plurality of claw-like portions that extend from an outer circumferential portion of the fastening section in an axial direction away from the piston.

14. The lockup device recited in claim 1, wherein
the input member is inserted between rotational end portions of adjacent first elastic members in an axial direction from a piston side of the damper mechanism such that the damper mechanism is removable in an axial direction away from the piston.

15. The lockup device recited in claim 14, wherein
the input member has a fastening section that is fastened to the piston and a plurality of claw-like portions that extend from an outer circumferential portion of the fastening section in the axial direction away from the piston.

16. The lockup device recited in claim 15, wherein
the intermediate member is supported in a radial direction by the output member.

17. The lockup device recited in claim 1, wherein
the input member has a fastening section that is fastened to the piston and a plurality of claw-like portions that extend from an outer circumferential portion of the fastening section in an axial direction away from the piston.

18. The lockup device recited in claim 17, wherein
the intermediate member is supported in a radial direction by the output member.

19. The lockup device recited in claim 1, wherein
the intermediate member is supported in a radial direction by the output member.

20. A fluid-type power transmitting device comprising:
an input rotary body provided to receive an input of power;
an output rotary body provided to output power received by the input rotary body; and
a lockup device mechanically coupling the input rotary body and the output rotary body together, the lockup device having
a piston provided to be frictionally coupled to the input rotary body,
an input member fixed to the piston, and
a damper mechanism elastically coupling the piston and the output rotary body in a rotational direction, the damper mechanism including
a plurality of first elastic members provided to receive power transmitted from the piston via the input member,
a plurality of second elastic members arranged farther inward in a radial direction than the first elastic members,
an intermediate member supporting the first and second elastic members to allow the first and second elastic members to operate in series and to undergo elastic deformation in a rotational direction, and
an output member fixed to the output rotary body and provided to touch against an end portion of the second elastic members in a rotational direction.
